(19) United States
(12) Patent Application Publication
(10) Pub. No.: US 2011/0128154 A1
(43) Pub. Date: Jun. 2, 2011

(54) BATTERY ELECTROLYTE LEVEL INDICATOR

(75) Inventors: Mark W. Herrema, Rockford, MI (US); Roger D. Burdi, Ada, MI (US)

(73) Assignee: FLOW-RITE CONTROLS, LTD., Byron Center, MI (US)

(21) Appl. No.: 12/628,615

(22) Filed: Dec. 1, 2009

(51) Int. Cl. G08B 21/00; H01M 10/48; G01N 27/42

(52) U.S. Cl. 340/636.21; 429/92; 324/425

(57) ABSTRACT

A battery electrolyte monitor including a probe and a control circuit. The control circuit includes a capacitive element within the probe. The probe is acid resistant, and therefore the probe protects the capacitive element from contact with the battery electrolyte. The control circuit periodically charges and discharges the capacitive element using direct current. Depending on at least one of a charging characteristic and a discharging characteristic, the control circuit determines the electrolyte level. If the electrolyte is below a desired minimum level, the control circuit illuminates an indicator light.

### BACKGROUND OF THE INVENTION

The present invention relates to lead-acid batteries, and more particularly to devices for monitoring and indicating the level of electrolyte within lead-acid batteries.

The proper functioning of a lead-acid battery requires a proper level of electrolyte in each battery cell. If a battery is used with under-filled cells, permanent loss of capacity may result from sulfation of the exposed plates and from excess operating temperature. Additionally, the heat induced from the associated short-circuiting introduces the possibility of explosion due to ignition of cell gasses.

Accordingly, and especially in the field of industrial batteries, it is standard practice to locate a powered probe within a battery cell to measure the level of the electrolyte in the cell. The two main methods for measuring electrolyte levels are 1) a conductive probe unit and 2) an AC powered, locally grounded, capacitance-sensing probe.

The conductive probe unit is based on the principle that when the conductive probe contacts the electrolyte, electricity can flow through the probe and the electrolyte in a closed circuit. A control circuit within the unit monitors for an open circuit condition and alerts the battery user appropriately. Examples of this technology are disclosed in U.S. Pat. No. 5,936,382 issued Aug. 10, 1999 to Jones et al and U.S. Pat. No. 6,040,079 issued Mar. 21, 2000 to Mcmurren.

Unfortunately, conductive probe units have several shortcomings. First, the conductive probe of the unit, which extends into the battery cell, erodes with age. Conductive materials, when placed in an acid environment such as a battery cell, are susceptible to corrosion especially when subjected to electrical current. As the probe material corrodes, particles dislodge from the base probe material; and the probe erodes. An eroded or shortened probe renders the electrolyte level indicator ineffective for accurately determining the electrolyte level. Second, the conductive probe can come into contact with internal cell structure, such as moss shields or lead straps. And such contact can cause a false reading, indicating adequate electrolyte level when in fact the level is low.

The capacitance-sensing probe is a more recent development. An example of such a probe is illustrated in U.S. Pat. No. 6,943,566 issued Sep. 13, 2005 to Florin et al. This type uses alternating current (AC) to measure the capacitance of the electrolyte and the probe that extends into the electrolyte. Current flows between the electrolyte and the probe through the AC circuit. The capacitance of the system changes as the electrolyte level changes, and consequently the capacitance provides an indication of electrolyte level. This change is monitored, and the unit alerts the battery user appropriately.

Unfortunately, capacitance-sensing probes also have shortcomings. First, the probe that extends into the battery electrolyte is an exposed metal, which erodes as discussed above. Second, the probe can contact internal cell structure as discussed above. Third, because the electrical current must flow between the unit and the electrolyte, the probe must be grounded to the cell that it is monitoring. This required grounding is unique to these types of systems and therefore can create confusion during the installation process.

### SUMMARY OF THE INVENTION

An electrolyte level indicator constructed in accordance with the present invention includes a probe (a) that does not erode, (b) that does not create problems if it contacts solid structure inside a battery cell, and (c) that includes a control circuitry that is independent of the cell being monitored. The level indicator uses capacitance sensing to determine the level of the electrolyte. The level indicator includes a probe having a housing and a capacitive element within the housing. The probe housing is electrically nonconductive and acid resistant, which protects the capacitive element within the housing.

The capacitive element within the probe is regularly charged and discharged using direct current. The control circuit monitors the charge and discharge properties to identify charge and discharge profiles or characteristics. When the encapsulated probe is near or in contact with the electrolyte, the discharge properties of the probe change. The control circuit monitors these changes to determine electrolyte level, and alerts the battery user appropriately. Lights, such as LEDs, can provide the alert to the user.

The probe of the present invention addresses the noted shortcomings of prior art units. First, the probe does not corrode or erode. Second, the probe does not provide a false signal if it comes into contact with solid structure or contaminants inside the battery cell. Therefore, the probe is insensitive to moss shields, lead straps, and contaminants such as oils. Third, the probe enhances safety. Explosions have occurred with some regularity in cells containing metal-probed level indicators. A common theory is that electrical current flowing through a metal probe can produce a spark, which can ignite the flammable gasses produced by a battery. The nonconductive probe housing of the present invention electrically insulates the probe from the electrolyte so that a spark cannot jump between the two, possibly leading to an explosion. Fourth, the level indicator uses direct current to monitor the electrolyte level. The circuit is powered externally and is not grounded to the cell in which it is mounted. Consequently, no current flows into the electrolyte or battery cell.

The length of the probe is selected based on the desired electrolyte level for a given application. Additionally, the indicator light can be included integrally with the probe unit and/or provided in a separate unit that can be mounted on the edge of the battery.

These and other advantages and features of the invention will be more fully understood and appreciated by reference to the description of the current embodiments and the drawings.

### BRIEF DESCRIPTION OF THE DRAWINGS

FIG. 1 is a perspective view of the battery electrolyte level indicator in accordance with a first embodiment of the invention;

FIG. 2 is a fragmentary perspective view showing the level indicator installed within a lead-acid battery;

FIG. 3 is a sectional view showing the level indicator installed on a battery;

FIG. 4 is a perspective view of the probe housing;

FIG. 5 is a sectional view of the probe housing;

FIG. 6 is a top plan view of the probe housing;

FIG. 7 is a perspective view of the indicator cap;

FIG. 8 is a bottom plan view of the indicator cap;

FIG. 9 is a schematic diagram of the control circuit for the indicator;

FIG. 10 is a flow chart illustrating the operation of the control circuit;

FIG. 11 is a perspective view showing a second embodiment of the level indicator in which the indicator light is contained in a housing separate from the probe assembly;

FIG. 12 is a perspective view of the separate light housing; and

FIG. 13 is a bottom plan view of the separate light housing.

### DESCRIPTION OF THE CURRENT EMBODIMENTS

### I. First Current Embodiment

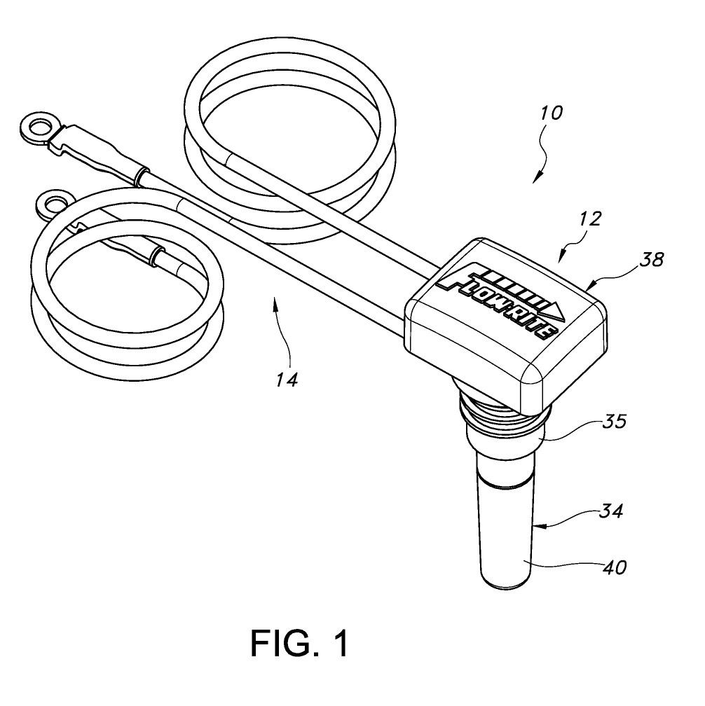

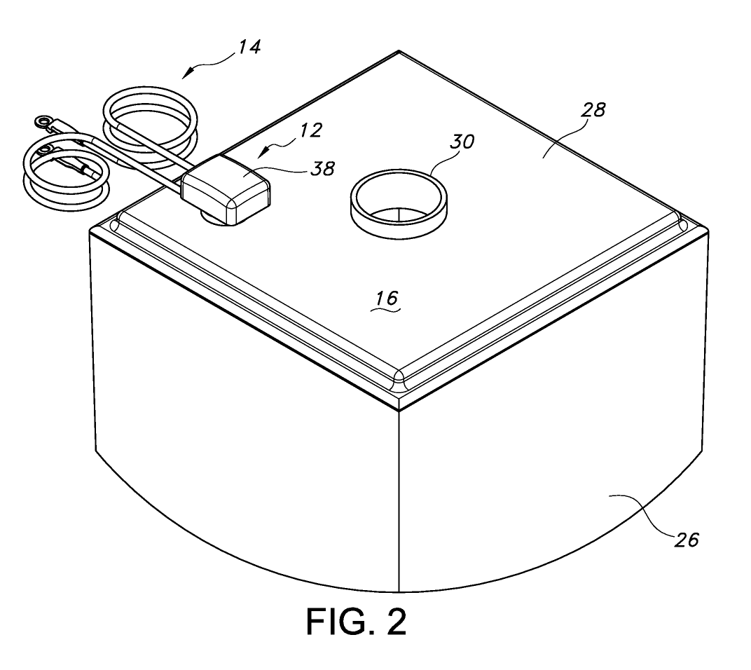

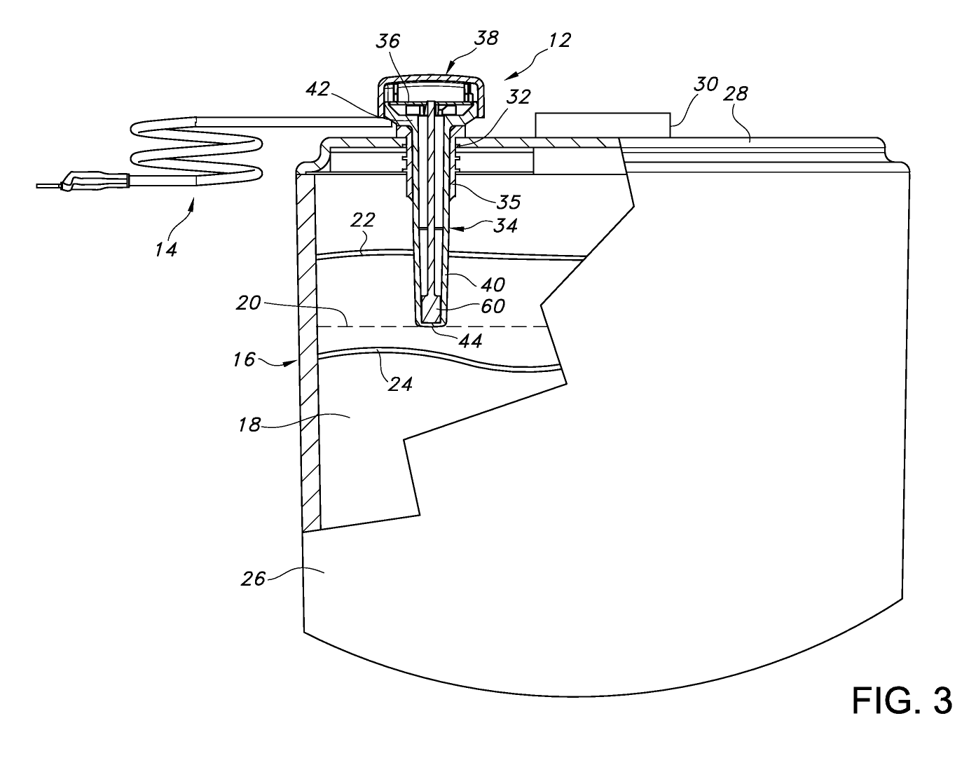

A battery electrolyte level monitor constructed in accordance with a first embodiment of the invention is illustrated in FIGS. 1-10 and generally designated 10. The level indicator 10 includes a probe assembly 12 and a pair of electrical leads 14. As shown in FIGS. 2-3, the probe assembly 12 extends into a battery 16 containing electrolyte 18. The lower end 44 of the probe assembly 12 is located at the desired minimum electrolyte level 20 when the level indicator 10 is installed on the battery 16. If the electrolyte is above the minimum level 20 as indicated at 22, the level indicator 10 provides a first indication such as a green light. If the electrolyte level falls below the minimum level 20 as indicated at 24, the level indicator 10 provides a second indication such as a red light, indicating that the battery 16 requires water.

Lead-acid batteries, such as the battery 16, are well-known in the art and will not be described in detail. Suffice it to say that the battery 16 includes a case 26 containing the other components. The battery includes one or more cells each containing an electrolyte 18. The battery also includes a top 28 defining ports 30 and 32, which provide access for inspecting the battery, adding electrolyte, and/or receiving watering systems. The electrolyte is consumed, albeit gradually, during operation of the battery and must be replenished periodically. Such replenishment is typically referred to as “watering”.

The probe assembly 12 includes a probe housing 34, a printed circuit board (PCB) 36 (see FIG. 3), and a cap 38.

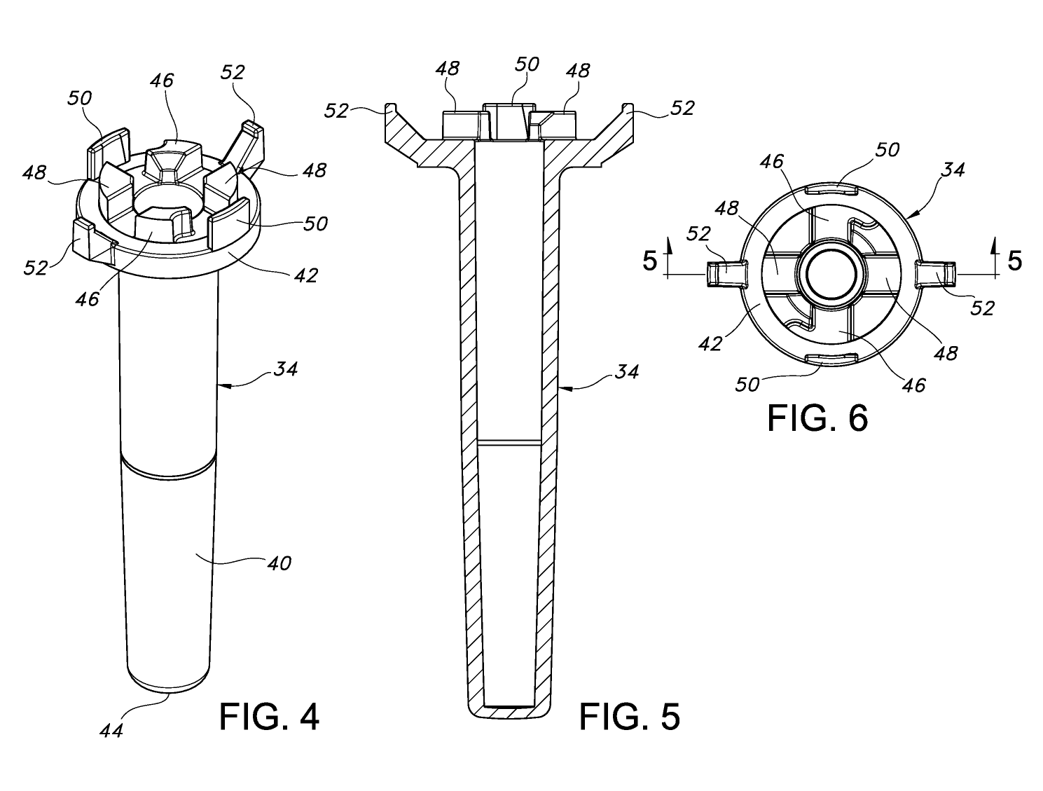

The probe housing 34 is perhaps best illustrated in FIGS. 4-6. The probe housing is a single, injection-molded piece including an elongated, hollow probe portion 40 and a top 42. The probe portion 40 has a length corresponding to the desired extension into the battery cell, so that the lower end 44 of the probe portion 40 is positioned at the minimum electrolyte level 20 (see FIG. 3). The top 42 includes a plurality of supports 46 and 48 and standoffs 50 and 52. The supports 46 and 48 support the printed circuit board 36 on the top 42, and the standoffs 50 and 52 locate the printed circuit board.

The probe 34 includes a grommet 35 mounted on the probe portion 40. The grommet is of conventional design to support and seal the indicator 12 within the battery 16.

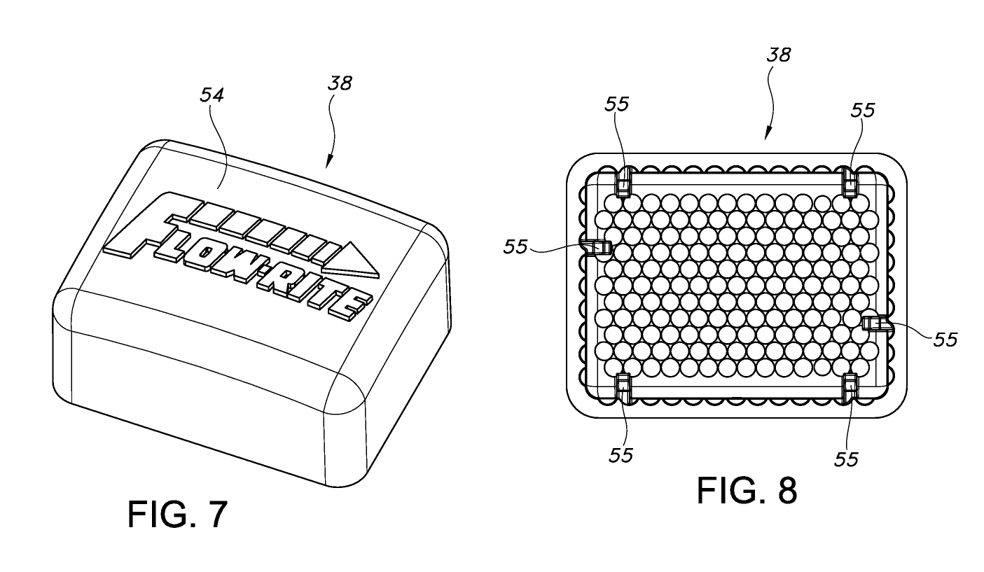

The cap 38 is perhaps best illustrated in FIGS. 7-8. The cap 38 is generally rectangular including a top 54, which may include an integrally molded trademark or other indicia. The interior surface of the cap 38 is illustrated in FIG. 8 and is treated to enhance light distribution properties. Consequently, the distribution of light from the indicator LED (described below) is enhanced because of this surface treatment. The cap 38 includes a plurality of standoffs 55, which locate the printed circuit board 36. The PCB 36 is sandwiched between the standoffs on the probe 34 and the cap 38. The cap 38 is filled with a transparent or semi-transparent epoxy, which intersecures the probe 34, the PCB 36, and the cap The assembly, including the epoxy, provides a water-resistant and electrolyte-resistant enclosure.

The material of which the probe 34 is currently fabricated is both electrically nonconductive and acid resistant. The material of the current embodiment is ABS, although a wide variety of other materials could be used. The material prevents electrical conductivity between the capacitive element 60 and the battery electrolyte 18. Further, the probe 34 encapsulates the capacitive element 60 to prevent the element from being contacted by the electrolyte 18; and therefore the capacitive element 60 is not subject to corrosion or erosion.

The material of which the cap 38 is currently fabricated is a clear polycarbonate to permit the transmission of light from the LEDs 68. Other suitable materials could be used.

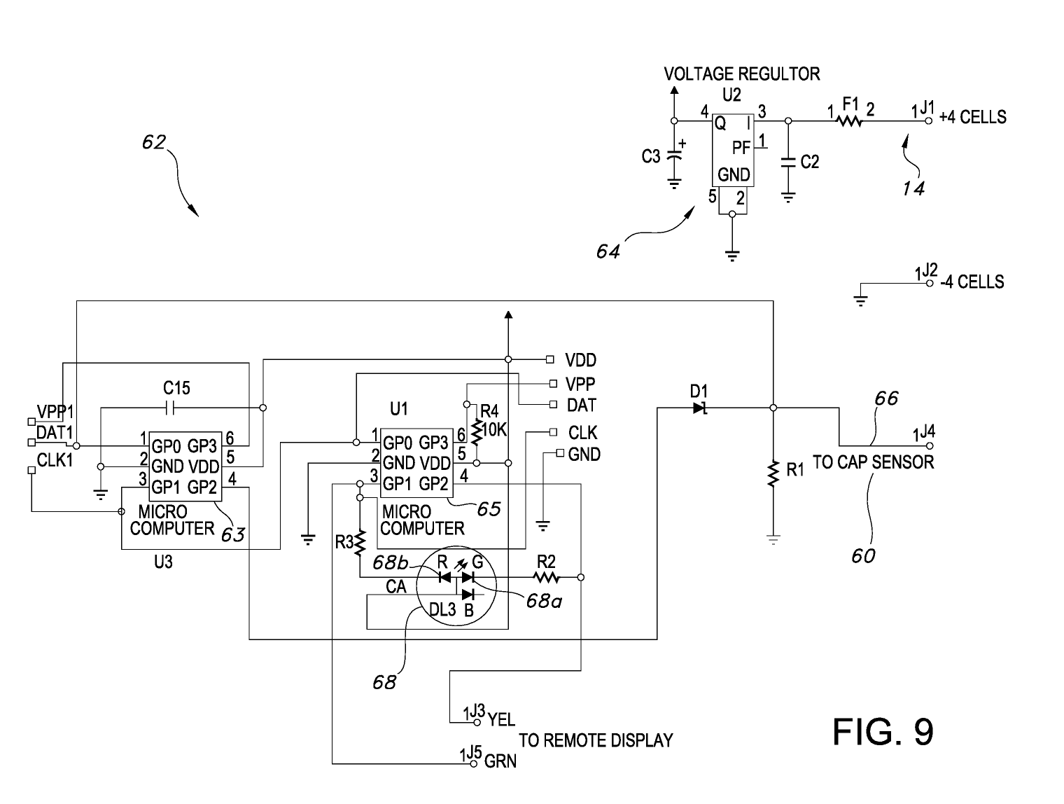

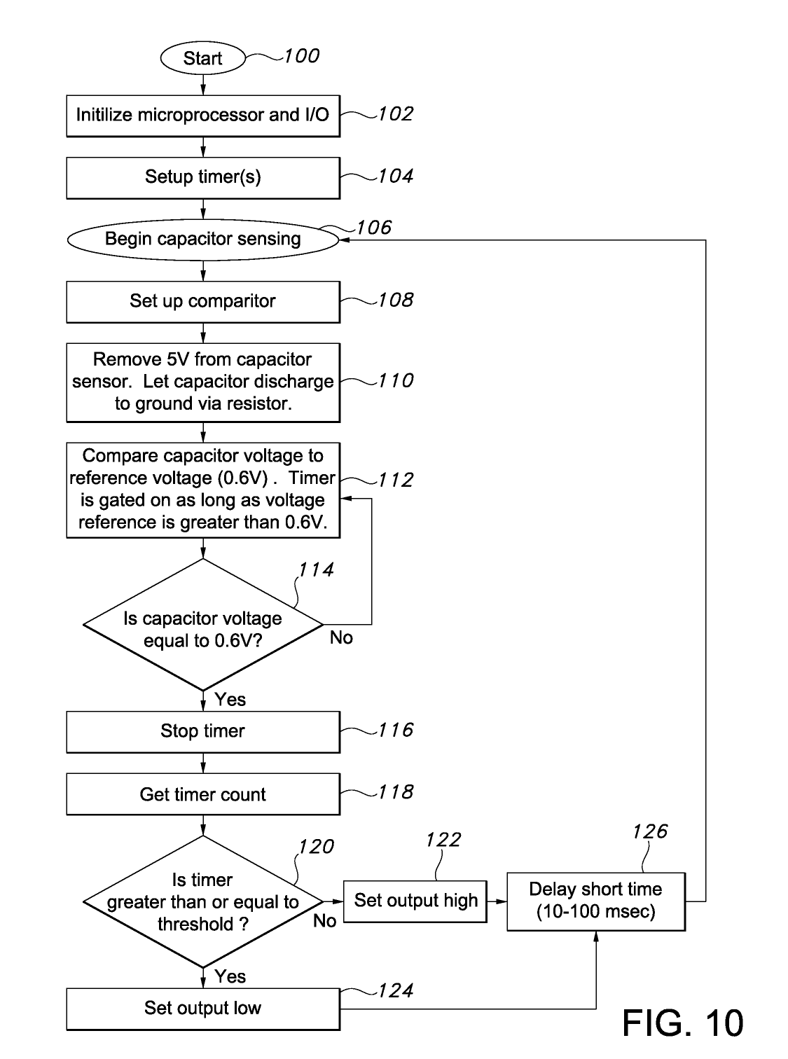

The control circuit 62 includes the PCB 36 (FIG. 3), which is of a type and construction generally well-known to those skilled in the electronics art. The control circuit also includes a capacitive element 60 (FIG. 3) located within the probe portion 40 adjacent two or closely proximate to the lower end 44 thereof. The capacitive element 60 is electrically connected to the PCB 36 in conventional fashion, for example by soldering. Additionally, the PCB 36 includes one or more board-mounted light emitting diodes (LEDs) (see FIG. 9).

An electrical schematic illustrating the control circuit 62 is illustrated in FIG. 9. The control circuit is powered by the electrical leads 14, which can be connected to the power terminals of the battery 16. Alternatively, the leads 14 can be connected to any other source of DC voltage. The control circuit includes a voltage regulator 64, a capacitance sense microcomputer 63, and a display microcomputer 65. The voltage regulator 64 provides power to the remainder of the circuit, including the microcomputers 63 and 65.

The pins of the circuit are defined as follows:

| | |
|---|---|
| VDD | 5-volt supply for both microcomputers |
| VPP | Programming voltage for the flash |
| | programmable ROM for the display |
| | microcomputer |
| DAT | Data for flash programming for the display |
| | microcomputer |
| CLK | Clock synchronization for flash programming |
| | for the display microcomputer |
| GND | Ground reference for both microcomputers |
| VPP1 | Connection point for programming voltage |
| | for the capacitor sense microcomputer |
| DAT1 | Connection point for programming data for |
| | the capacitor sense microcomputer |
| CLK1 | Connection point for programming clock for |
| | the capacitor sense micro |

The pins are used for programming the microcomputers 63 and 65 during production. The control circuit 62 alternatively can include pre-programmed microcomputers, which eliminates the need for the programming pins. Further alternatively, the control circuit 62 can include a single microcomputer in place the microcomputers 63 and 65.

The capacitive element 60 is electrically connected to the PCB 36 at point 66. The control circuit 62 includes red, green, and blue light-emitting diodes 68 which are controlled to provide a visual indication to the battery user of the electrolyte level. In the current embodiment, the green LED is illuminated when the electrolyte level is above the minimum electrolyte level 20; and the red LED is illuminated when the electrolyte level is below the minimum electrolyte level 20.

The leads 14 are conventional and are connected to the probe assembly 12 in conventional fashion to provide power to the control circuit 62.

FIG. 10 is a flow chart showing the operation of the control circuit 62. Program flow begins 100 with the initialization 102 of the microcomputers 63 and 65 and of the inputs and outputs. Timers are set up or initiated 104. Capacitor sensing then begins 106 by setting up or initiating 108 the comparator. The 5-volt rail voltage is removed 110 from the capacitor 60 to allow the capacitor to discharge to ground. During discharging, the voltage of the discharging capacitor 60 is compared 112 to a reference voltage of 0.6 volts. If the capacitor voltage is equal to the 0.6 volt reference 114, then the timer is stopped 116 and the timer count is obtained 118. If the capacitor is not equal to the 0.6 volt reference 114, then control returns to block 112. If the timer count is greater than or equal to a predetermined threshold 120, then the output is set high 122 to illuminate the green LED 68a (see FIG. 9). If the timer count is not greater than or equal to the predetermined threshold 120, then the output is set low 124 to illuminate the red LED 68b. After either step 122 or 124, the short delay in the range of 10 milliseconds (ms) to 100 ms occurs 126, and program flow returns to step 106. The predetermined threshold corresponds to a discharge time that is appropriate for the battery 16 and the electrical components within the control circuit 62. The discharge time defines a discharging profile. Alternatively, the charging time can be monitored in an analogous manner to define a charging profile. The control circuit 62 can use either or both of the discharging profile and the charging profile to determine the level of electrolyte within the cell. It will be recognized by those skilled in the art that the specific values of all of the parameters in this specification are for illustration only, and that one or all of the values can be changed in view of the battery and the desired performance.

The first embodiment of the level indicator 10 is sometimes referred to as the “local” embodiment because all of the components (except the leads 14) are contained within the probe assembly 12.

### II. Assembly and Operation of the First Current Embodiment

Assembly of the indicator 12 is straightforward. The probe housing 34 and the cap 38 are injection molded. The capacitive element 60 is inserted into the probe 34 so that the capacitive element 60 is located adjacent or closely proximate to the lower end 44 of the probe housing 34. The PCB 36 is mounted on the top 42 of the probe 34, is supported on the supports 46 and 48, and located by the standoffs 50 and 52 (see FIGS. 3-6). The leads 14 are mechanically connected to the probe assembly 12 and are electrically connected to the PCB 36 in conventional fashion. The probe 34 with the PCB 26 is inserted into the cap 38. The cap is then filled with epoxy (not shown), so that the cap, the probe, and the epoxy collectively encase the printed circuit board 36 to provide a water-resistant and electrolyte-resistant assembly.

The probe assembly 12 is mounted on the battery 16 by inserting the probe housing 34 through the port 32. The grommet 35 engages the battery to both support and seal the probe assembly 12 within the battery 16. The leads 14 are connected to a source of DC voltage such as the power terminals of the battery 16.

In operation, the capacitive element 60 is repetitively or periodically charged and discharged using direct current. Each charging and discharging of the capacitive element 60 results in a profile or characteristic that is dependent upon the level of the electrolyte 18. If the electrolyte is above the minimum level 20 as illustrated at 22, the charging and discharging have first profiles. And, if the electrolyte 18 is below the minimum level 20 as illustrated at 24, the charging and discharging have second profiles. When the control circuit 62 determines, based on at least one of the charging profile and the discharging profile, that the electrolyte level is above the minimum level 20, the green LED is illuminated. When the control circuit 62 determines that the electrolyte level is below the minimum level 20, then the red LED is illuminated. If desired, the LEDs can flash in a regular or irregular pattern to further attract attention. Alternatively, other indicator techniques can be used such as audible alerts and/or wireless signals. Another possibility is for the control circuit 62 to control an automatic watering system, so that water would be added to the battery 16 automatically upon determination that the electrolyte level is below the minimum level.

### III. Second Current Embodiment

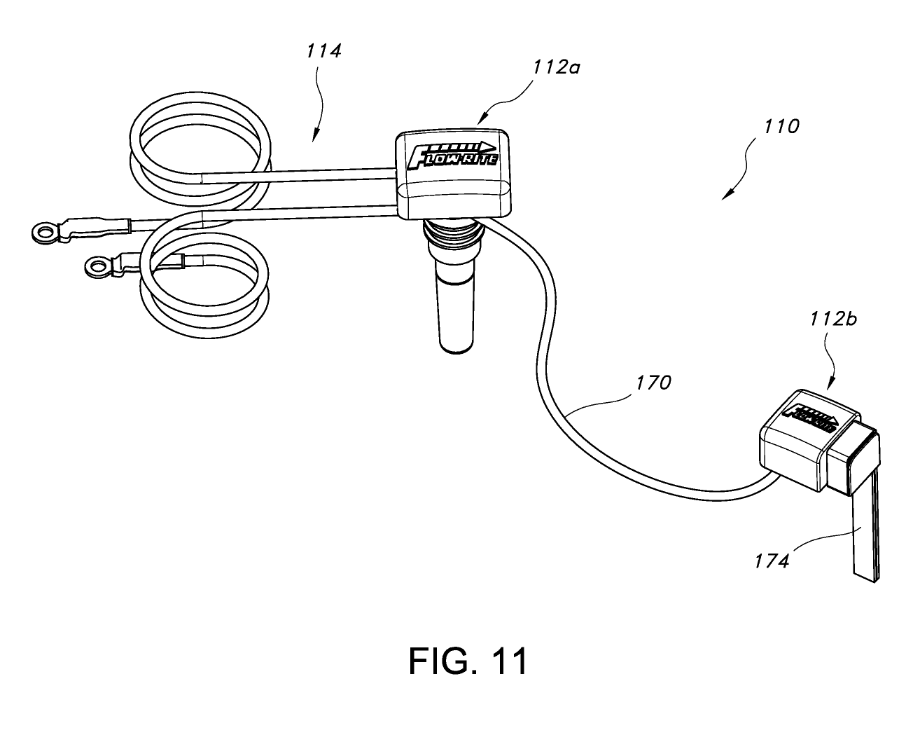

An indicator system constructed in accordance with a second embodiment of the invention is illustrated in FIG. 11 and generally designated 110. The second embodiment is sometimes referred to as the “remote” embodiment because a second housing 112b containing the indicator LEDs 68 is separate from the probe assembly 112a.

The probe assembly 112a is generally identical to the probe assembly 12 of the first embodiment with one exception. The probe assembly 112a does not include an indicator light, such as the LEDs 68. In the second embodiment 110, the indicator LEDs 68 are included within a second or light housing 112b connected to the indicator 112a by a cable 170.

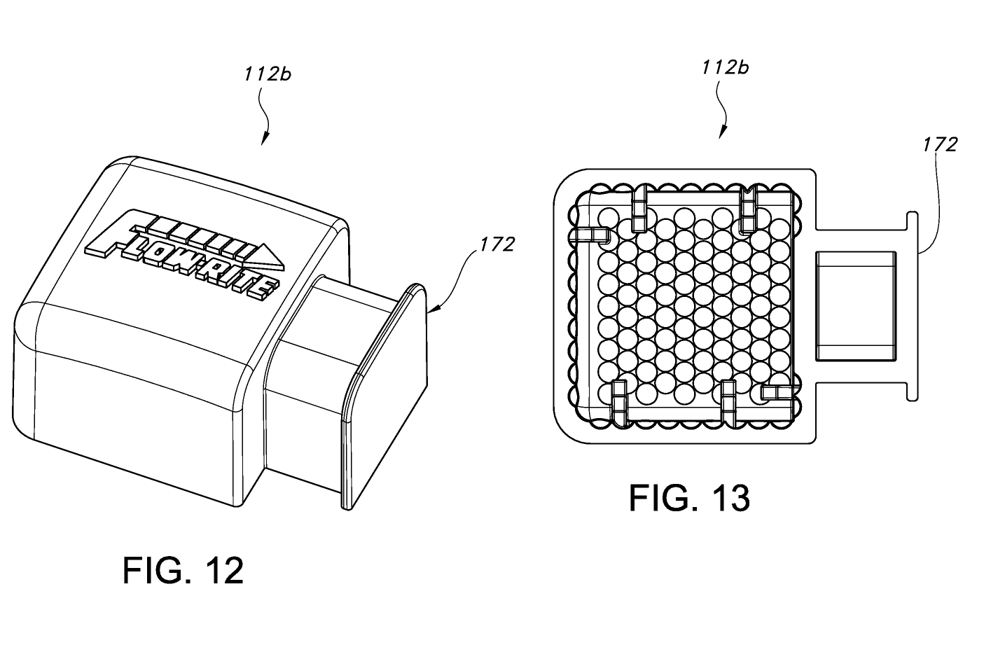

The light housing 112b is injection molded similar to the housing 12 previously described. The housing 112b includes a printed circuit board (not shown) having one or more board-mounted LEDs thereon. As illustrated in FIGS. 12-13, the exterior and interior of the housing 112b are configured to increase light distribution from the LEDs contained therein. The light housing also includes a socket 172 on one side thereof. The socket 172 can receive a spade 174 (see FIG. 11), which can be used for remotely positioning the housing 112b. For example, the housing 112b could be located at the edge or side of the battery 16, in which case the spade 174 could be fitted between the battery and the battery case (not shown) to support the housing 112b in position.

### IV. Operation of the Second Embodiment

The operation of the second embodiment 110 is generally identical to the operation of the first embodiment 10. The difference is that the indicator LEDs are provided at the edge or the side of the battery 16. In many applications, most notably industrial applications, such positioning of the indicator lights can facilitate observation through the serially aligned LEDs.

### V. Third Current Embodiment

An indicator system constructed in accordance with a third embodiment of the invention is not illustrated in the drawings. The third embodiment is sometimes referred to as the “local/remote” embodiment because both the probe assembly and the remote assembly include one or more indicator lights such as LEDs.

The above descriptions are those of the current embodiments of the invention. Various alterations and changes can be made without departing from the spirit and broader aspects of the invention as defined in the appended claims, which are to be interpreted in accordance with the principles of patent law, including the doctrine of equivalents.

1. A battery assembly comprising:
a battery having a cell adapted to receive and contain an electrolyte having a desired minimum level within the cell;
a probe extending into the cell, the probe including a probe housing and a capacitor within the probe housing, the probe housing being electrically non-conductive and acid resistant, the probe housing preventing contact between the electrolyte and the capacitor, the probe supporting the capacitor at the desired minimum level within the cell; and
a control circuit electrically connected to the capacitor within the probe housing, the control circuit adapted to charge and discharge the capacitor using direct current, to determine at least one of a charging characteristic and a discharging characteristic, and to determine whether the electrolyte level is at the desired minimum level as a function of at least one of the charging characteristic and the discharging characteristic.

2. (canceled)

3. A battery assembly as defined in claim 1 wherein the control circuit includes a printed circuit board supported by said probe housing.

4. A battery assembly as defined in claim 3 further comprising a light, and wherein the control circuit is adapted to switch the light between a first state when the electrolyte level is below the desired electrolyte level and a second state when the electrolyte level is above the desired electrolyte level.

5. A battery assembly as defined in claim 4 wherein the light is an LED board mounted on the printed circuit board.

6. A battery assembly as defined in claim 5 further comprising a cap attached to the probe housing and fitted over the printed circuit board, whereby the probe housing and the cap enclose the printed circuit board.

7. A battery assembly as defined in claim 4 wherein:
the battery includes a side; and
the light is located at the side of the battery.

8. A battery electrolyte level monitor comprising:
a probe including a probe housing and a capacitor within the probe housing, the probe housing being electrically non-conductive and acid resistant, the probe housing preventing contact between the capacitor and electrolyte within a battery cell when the probe is inserted into the battery cell, the capacitor being located within the probe housing so as to be supported at a minimum electrolyte level when the probe is supported within a battery cell; and
a control circuit electrically connected to the capacitor, the control circuit adapted to charge and to discharge the capacitor using direct current, the control circuit adapted to determine at least one of a charging characteristic and a discharging characteristic related to the charging and the discharging respectively, the control circuit adapted to determine as a function of the at least one charging characteristic and the discharging characteristic whether the electrolyte is above or below the minimum electrolyte level.

9. (canceled)

10. A battery electrolyte level monitor as defined in claim 8 wherein the control circuit includes a printed circuit board supported by the probe housing.

11. A battery electrolyte level monitor as defined in claim 10 further comprising a light, and wherein the control circuit is adapted to switch the light between a first state when the electrolyte level is below the minimum electrolyte level and a second state when the electrolyte level is above the minimum electrolyte level.

12. A battery electrolyte level monitor as defined in claim 11 wherein the light is an LED board mounted on the printed circuit board.

13. A battery electrolyte level monitor as defined in claim 12 further comprising a cap attached to the probe housing and fitted over the printed circuit board, whereby the probe housing and the cap enclose the printed circuit board.

14. A battery electrolyte level monitor as defined in claim 11 wherein the light is adapted to be located remotely from the probe.

15. A method of determining the level of an electrolyte within a battery, the method comprising:
inserting a probe into a cell of the battery, the probe being electrically non-conductive and acid resistant, the probe containing a capacitor, the probe supporting the capacitor at a minimum electrolyte level;
charging the capacitor using direct current;
discharging the capacitor using direct current;
determining at least one of a charging characteristic and a discharging characteristic associated with the charging step and the discharging step respectively; and
determining whether the actual electrolyte level is above or below the minimum electrolyte level as a function of the preceding determining step.

16. (canceled)

17. A method as defined in claim 15 further comprising switching a light between a first state when the electrolyte level is below the minimum electrolyte level and a second state when the electrolyte level is above the minimum electrolyte level.

18. A method as defined in claim 17 further comprising board mounting the light on a printed circuit board supported by the probe.

19. A method as defined in claim 18 further comprising attaching a cap to the probe and fitting the cap over the printed circuit board, whereby the probe and the cap enclose the printed circuit board.

20. A method as defined in claim 17 further comprising locating the light at a side of the battery.
